(19) United States
(12) Patent Application Publication
(10) Pub. No.: US 2005/0239315 A1
(43) Pub. Date: Oct. 27, 2005

(54) Apparatus and method for connecting a subscriber line to a transceiver

(76) Inventor: Scott Carden, Huntsville, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/828,803

(22) Filed: Apr. 21, 2004

(51) Int. Cl. H01R 13/627

(52) U.S. Cl. 439/359

(57) ABSTRACT

A connector for connecting a subscriber line to an electrical component comprises a housing having a receiving slot. The connector further comprises a clip slidably coupled to and retained by an inner wall of the housing, the inner wall defining the receiving slot.

### RELATED ART

A telecommunication network typically comprises a central office that services a large number of customers. Customer premise equipment (CPE) that transmits and receives data is located at each customer's site, and the CPE is connected to an electrical component, e.g., a transceiver, at the central office via a pair of wires often referred to as a “subscriber line.” A large number of subscriber lines are usually bundled in a single cable, sometimes referred to as a “subscriber line cable.” For example, a typical cable may comprise sixty wires that carry thirty signals from thirty different central office transceivers communicating over thirty different subscriber lines.

Oftentimes, a plurality of transceivers are supported by a chassis having a receptacle that is interfaced with each transceiver. Each subscriber line cable is usually terminated with a header connector that is received by the receptacle of the chassis. Mating the header connector with the receptacle establishes an electrical connection between transceivers mounted in the chassis and the subscriber line bundled in the cable.

In particular, when the header connector and receptacle are mated, each wire pair within the cable is electrically coupled, through the receptacle, to a respective transceiver held by the chassis. Thus, signals communicated by the transceivers held by the chassis may be carried by the subscriber lines of the cable that is mated with the chassis' receptacle.

A typical header connector has a plastic housing that enables the header connector to easily break away from a chassis' receptacle in response to a small force that pulls the cable from the chassis' receptacle. Such a header connector prevents damage to the receptacle to which it is connected when the cable experiences a small force by releasing the cable.

### SUMMARY OF THE DISCLOSURE

Generally, the present disclosure provides a header connector that can be securely attached to an electrical component.

A connector for connecting a subscriber line to a transceiver in accordance with an embodiment of the present disclosure comprises a housing having a receiving slot. The connector further comprises a clip slidably coupled to and retained by an inner wall of the housing, the inner wall defining the receiving slot.

A method in accordance with an embodiment of the present invention comprises the steps of providing a housing with a slot that has protruding inner walls and providing a clip with feet, the feet having tabs. The method further comprises slidably engaging the feet of the clip with the inner walls of the slot, securing the tabs of the feet to receiving depressions in the inner walls, and inserting the housing into a receptacle of a chassis establishing an electrical connection to the transceiver mounted in the chassis.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating a communication system.

FIG. 2 is a perspective view illustrating a chassis as shown in FIG. 1 and a conventional connector.

FIG. 3 is an exploded view of the conventional connector of FIG. 2.

FIG. 4 is a perspective view of the conventional connector of FIG. 2.

FIG. 5 is a perspective view illustrating a chassis depicted in FIG. 1 and a connector in accordance with an exemplary embodiment of the present disclosure.

FIG. 6 is an exploded view of the connector depicted in FIG. 5.

FIG. 7 is a perspective view of the connector depicted in FIG. 5.

FIG. 8 is a perspective view of an exemplary clip of the connector depicted in FIG. 4.

FIG. 9 is a flow chart illustrating an architecture and functionality of the connector depicted in FIG. 5.

FIG. 10 is a front perspective view of the clip of FIG. 8.

FIG. 11 is an bottom perspective view of the clip of FIG. 8.

FIG. 12 is a front plan view of the clip of FIG. 8.

FIG. 13 is a top plan view of the clip of FIG. 8.

FIG. 14 is a side plan view of the clip of FIG. 8.

FIG. 15 is a cross-sectional side plan view of the clip of FIG. 8.

### DETAILED DESCRIPTION

Embodiments of the present disclosure generally pertain to connectors for terminating electrical cables, such as subscriber cables, that may be used to carry signals communicated by transceivers of a communication system.

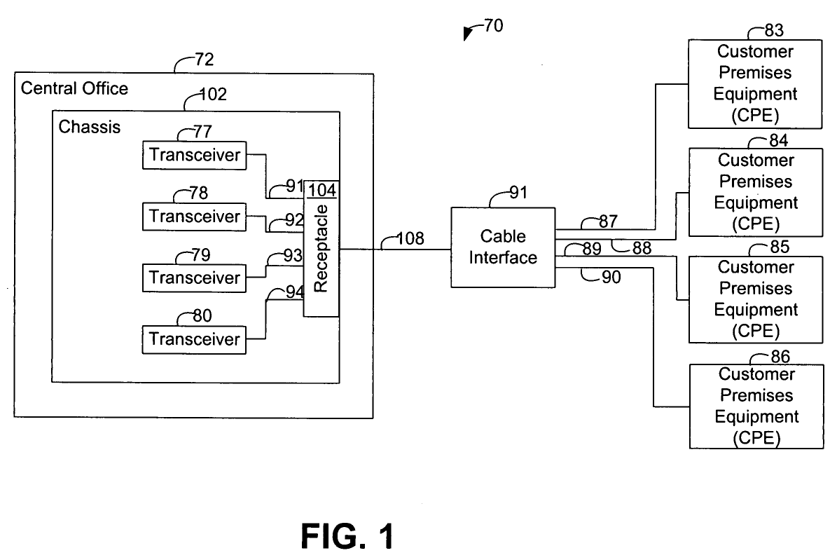

FIG. 1 is a block diagram illustrating a communication network system 70 having a central office 72 and customer premises equipment (CPE) 83-86. Each CPE 83-86 is connected to the central office 72 by a subscriber line 87-90. Each subscriber line 87-90 may comprise a pair of wires, sometimes referred to as a twisted pair.

The central office 72 comprises a chassis 102 that houses at least one transceiver 77-80. Note that while four transceivers 77-80 are shown in the communication system 70, the chassis 102 may comprise more or less transceivers than four. However, for ease of diagram and explanation, the communication system 70 of FIG. 1 depicts only the four transceivers 77-90 held in the chassis 102.

The cable interface 91, such as a feeder distribution interface, is connected to the subscriber lines 87-90. A cable 108 extending from the central office 72 to the interface 91 binds each of the subscriber lines 87-90.

The receptacle 104 receives the cable 108 and is electrically connected via connections 91-94 to a plurality of transceivers 77-90. Note that the number of transceivers held by the chassis 102 may correspond to the number of subscriber lines 87-90 received by the receptacle 104.

In operation, each CPE 83-86 communicates with the central office 72 over the subscriber lines 87-90, i.e., transmits and receives signals to and from the central office 72. In this regard, each CPE 83-86 receives data from and transmits data to at least one corresponding transceiver 77-80.

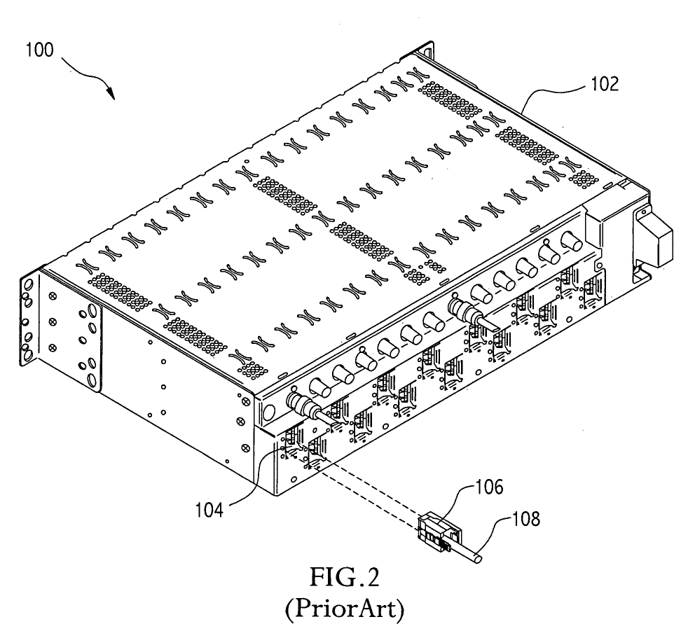

FIG. 2 depicts a system 100 having a conventional chassis 102 that may be used to hold transceivers 77-80 (FIG. 1). The chassis 102 receives the cable 108 that can be coupled to a conventional header connector 106, which is received by the chassis' receptacle 104. In this regard, the header connector 106 may be inserted into the receptacle 104 of the chassis 102 and when the header connector 106 is so inserted into the receptacle 104, the subscriber lines 87-90 bound by the cable 108 are electrically connected to electrical connections 91-94 (FIG. 1), respectively, thereby establishing a communication path through the cable 108, the connector 106, and to each transceiver 77-80 (FIG. 1) held by the chassis 102.

In FIG. 1, each of the electrical connections 91-94 is connected to a different transceiver 77080 such that each transceiver 77-80 is able to communicate over a different subscriber line 87-90 bound by the cable 108. However, in some examples, it may be desirable for one of the transceivers 77-80 to communicate over multiple subscriber lines, such as when the transceiver is communicating HDSL4 signals. In such an embodiment, multiple connections 91-94 may extend to the same transceiver to enable this transceiver to communicate over multiple subscriber lines.

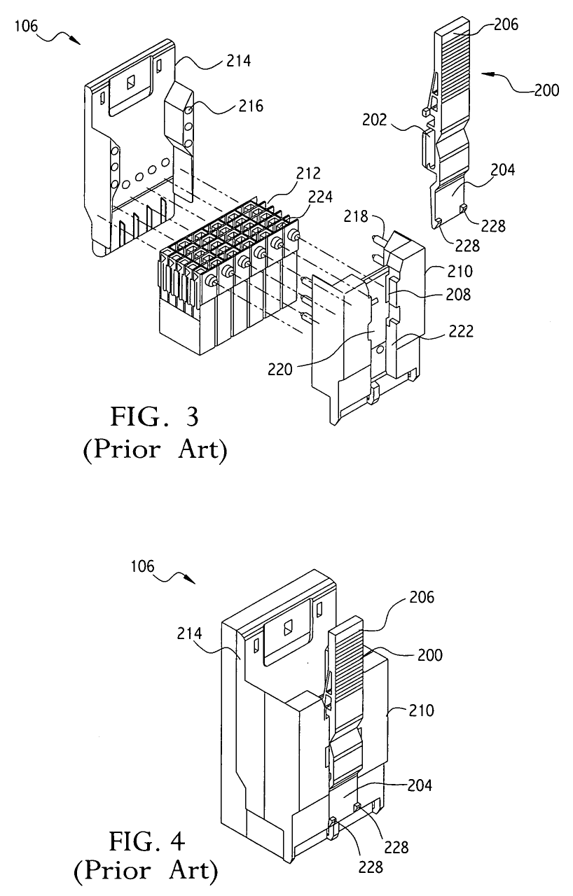

FIG. 3 depicts an exploded view of the conventional connector 106 of FIG. 2. The connector 106 has a wire receiving mechanism 212 that has a plurality of receptacles 224 for receiving the wires (not shown) of the cable 108 (FIG. 2). The wire receiving mechanism 212 is housed in a casing comprising a first section 214 and a second section 210 coupled via pins 218 of the second section 210 and pin openings 216 of the first section 214.

The connector 106 has a slot 220 with protruding inner walls 222. The protruding inner walls 222 have receiving depressions 226. The connector 106 further comprises a latch 200 having a shelf 202. The latch 200 is slidably received by the slot 220 and secured to the connector 106 via the shelf 202, which engages the portion 208 formed by the protruding inner walls 222. The latch 200 has a lever 206 and a platform 204. The platform 204 comprises protrusions 228.

FIG. 4 depicts a perspective view of an assembled connector 106. The first section 214 of the casing is attached to the second section 210 of the casing enclosing the wire-receiving mechanism 212 (FIG. 3). The latch 200 is slidably coupled to the connector 106. The connector 106 is inserted into an chassis 102 (FIG. 1) by depressing the ridged lever 206, which actuates the platform 204 in a direction toward the connector 106. Once the connector 106 is inserted into the receptacle 104 (FIG. 1), the lever 206 is released and the protrusions 228 move in a direction away from the connector 106 and catch on a lip (not shown) of the receptacle 104. While the connector 106 is positioned with the protrusions 228 in the receptacle 104, it is not securely held. In this regard, if the cable 108 (FIG. 2) is forcibly pulled, the protrusions 228 are such that the housing of the connector 106 breaks away.

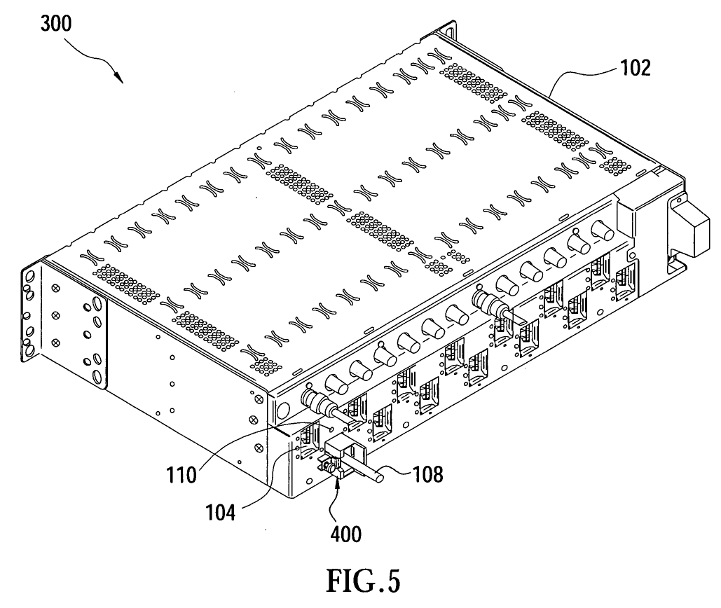

FIG. 5 depicts a system 300 having the chassis 102 that may be used to hold transceivers 77-80 of the central office 72 of FIG. 1. The chassis 102 receives the cable 108 that id coupled to a connector assembly 400 via the receptacle 104. In this regard, the connector assembly 400 may be inserted into the receptacle 104 of the chassis 102. When the connector assembly 400 is inserted into the receptacle 104, wires (not shown) in the cable 108 are electrically connected to electrical connections 91-94 (FIG. 1) thereby establishing a communication path through the cable 108, the connector assembly 400, and to each transceiver 77-80 (FIG. 1) held by the chassis 102.

When the connector assembly 400 is inserted into one of a plurality of receptacles 104, the assembly 400 is connected to the chassis 102 via one of a plurality of threaded openings 110 in the chassis 102.

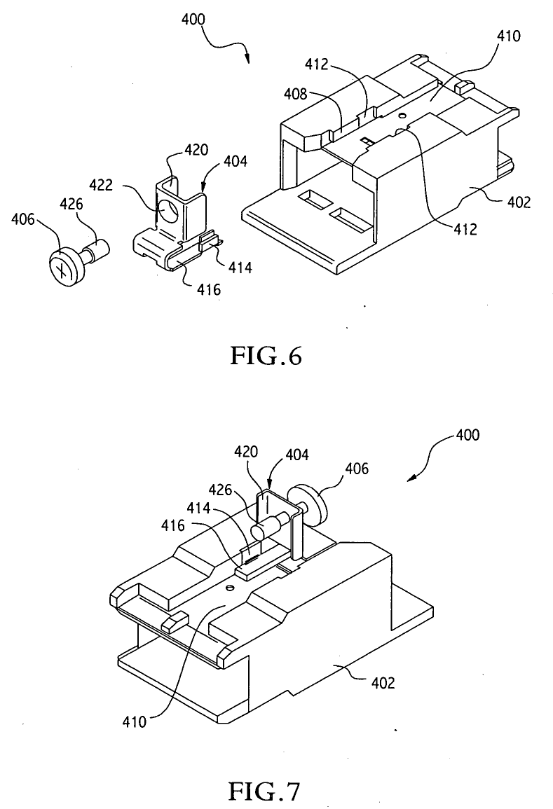

FIG. 6 depicts the connector assembly 400 having a housing 402, a clip 404, and a securing device 406, e.g., a screw. The housing 402 has a slot 410 with protruding inner walls 408. The protruding inner walls 408 comprise retaining depressions 412.

The clip 404 has feet 416 positioned substantially parallel with respect to each other and a protrusion 420 that is situated substantially perpendicular to the feet 416.

Note that in the view of FIG. 6, both feet 416 are not visible. However, a more detailed view of the clip 404 is further illustrated and described with reference to FIG. 6. The feet 416 comprise tabs 414, and the protrusion 420 has an opening 422. Preferably, the clip 404 is made of a flexible material, such as, for example, a thin flexible metal or plastic.

The clip 404 is slidably received by the slot 410, and the clip 404 is secured to the housing 402 by slightly deforming the feet 416 toward each other and inserting the clip 404 into the slot 410. When the clip 404 is moved far enough into the slot that the tabs 414 align with the retaining depressions 412, the tabs 414 fit snugly into the retaining depressions 412 when the feet reform to their original positions, i.e., substantially parallel with respect to one another. The securing device 406 is then inserted through the opening 422 thereby creating an assembled connector 400 as illustrated in FIG. 7.

Once a user inserts the connector 400 into the receptacle 104 (FIG. 5), the securing device 406 can then be used to secure the connector 400 to a threaded hole 110 in the chassis 102 (FIG. 5). For example, if the securing device is a screw, then the screw can be threadedly coupled to the threaded hole 110 (FIG. 5) in the chassis 102.

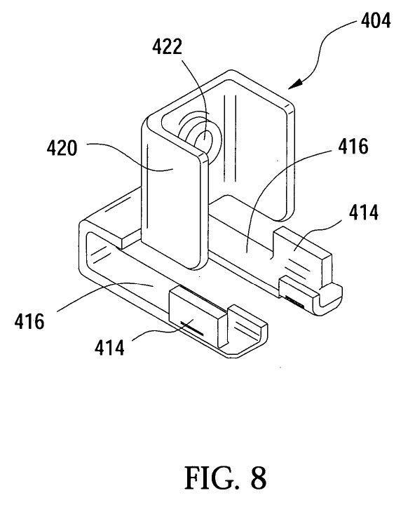

FIG. 8 depicts another perspective of the clip 404 of the connector 400 of FIGS. 6 and 7. The perspective of the clip 404 in FIG. 8 illustrates the substantially parallel feet 416 and the pair of tabs 414. As described hereinabove, the feet 416 slide into the slot 410 (FIG. 6) when the legs are deformed toward each other. When the tabs 414 are aligned with the retaining depressions 412 (FIG. 6), then the legs 416 reform to a substantially parallel position relative to one another. Thus, the tabs 414 fit snugly into the retaining depressions 412 and the clip 404 is retained by the inner protruding walls 408 of the housing 402.

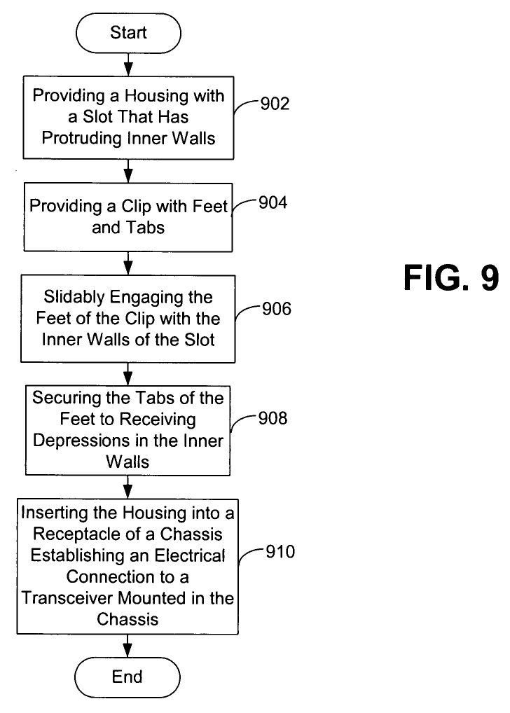

FIG. 9 depicts an exemplary method of the present disclosure for connecting a subscriber line cable 308 (FIG. 5) to a chassis 302 (FIG. 3).

The method comprises the step of providing a housing 402 (FIG. 6) with a slot 410 (FIG. 6) that has protruding inner walls 408 (FIG. 6), as indicated in step 902, and providing a providing a clip 404 (FIG. 6) with feet 416 (FIG. 6) and tabs 414 (FIG. 6), as indicated in step 904.

The next step comprises slidably engaging the feet 416 of the clip 404 with the inner walls 408 of the slot 410, as indicated in step 906. After the feet 416 are slidably engaged, the next step is securing the tabs 414 of the feet 416 to receiving depressions 412 (FIG. 6) in the inner walls 408, as indicated in step 908, then inserting the housing 402 into a receptacle 304 of a chassis 302 establishing an electrical connection to a transceiver mounted in the chassis 302, as indicated in step 910.

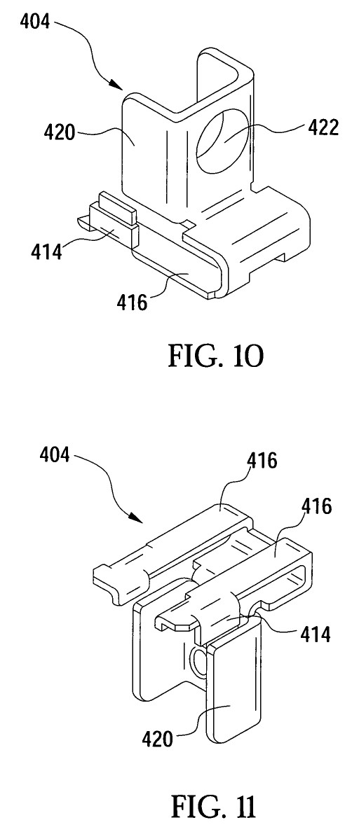

FIG. 10 is a frontal perspective view of the clip 404. The clip 404 comprises the portion 420 perpendicular to the feet 416. The portion 420 comprises the opening 422 through which a securing device 406 (FIG. 6), e.g., a screw, can be inserted when attaching the connector 400 (FIG. 5) to the chassis 102 (FIG. 5). Further illustrated is tab 414 that fits within the retaining depressions 412 (FIG. 6) that serves to attach the clip 404 to the connector housing 402.

FIG. 11 is a bottom perspective view of the clip 404. As shown by FIG. 11 the feet 416 are substantially parallel to one another. The feet 416 fit within the slot 410 (FIG. 6) thereby contacting the inner walls 408 of the slot 410. Further shown are tabs 414 that fit within the retaining depressions 412 (FIG. 6) of the slot 410.

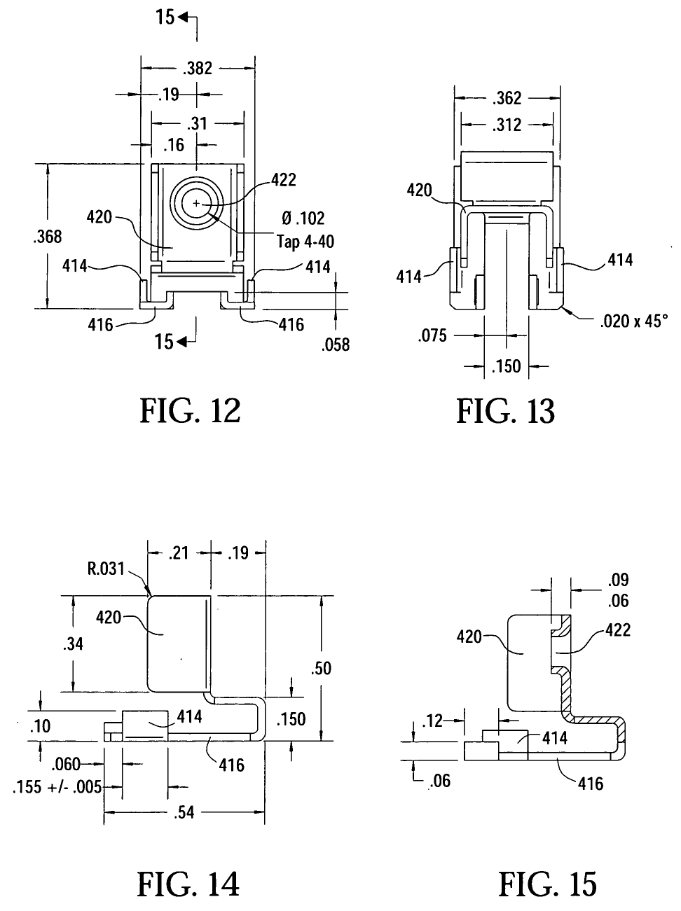

FIG. 12 is a front plan view of the clip 404 showing exemplary dimensions. As indicated, the exemplary clip 404 in FIG. 12 has a height of 0.368 inches and a width of 0.382 inches. The perpendicular portion 420 has an exemplary width of 0.31 inches, and the opening 422 is centered at 0.16 inches of the width of the perpendicular portion 420. The feet 416 extend from the perpendicular portion 420 approximately 0.058 inches, as indicated.

FIG. 13 is a top plan view of the clip 404. FIG. 13 illustrates an exemplary width of the feet 416 connected to the perpendicular portion 420 of 0.362 inches, and a separation distance between the feet 416 of 0.150 inches. Furthermore, FIG. 13 illustrates a 45° angle of 0.020 inches at the outside corners of the feet 416.

FIG. 14 is a side plan view of the clip 404. FIG. 14 indicates an exemplary length of the tabs 414 of 0.155 inches having a tolerance of 0.005 inches and a height of 0.1 inches. Further, the exemplary the feet 416 have exemplary lengths of 0.54 inches where the tabs are positioned approximately 0.060 inches from the ends of the feet 416.

Additionally, FIG. 14 indicates an exemplary height of 0.150 inches of the rounded portion of the feet 416 wherein that portion of the feet 416 that loops back and is connected to the perpendicular portion 420 is 0.19 inches in length. Furthermore, the length of the perpendicular portion 420 is indicated as 0.21 inches.

FIG. 15 is a cross-sectional side plan view of the clip 404 illustrating an exemplary opening 422 of the perpendicular portion 420. As indicated, the opening 422 is set within the perpendicular portion 420 approximately 0.09 inches.

Notably, the dimensions shown in and described with respect to FIGS. 12-15 are merely exemplary. Other dimensions are possible in other embodiments.

1. A connector for connecting a subscriber line to an electrical component, the connector comprising:
a housing having a receiving slot, the housing coupled to a plurality of receptacles for receiving the subscriber line and electrically coupling the subscriber line to the electrical component, the electrical component having a surface having at least one first opening and a connector receptacle; and
a clip having a first foot slidably coupled to an inner wall of the housing, the inner wall defining the receiving slot, the clip further having an attachment portion and a second opening through the attachment portion, the attachment portion positioned such that the second opening substantially aligns with the first opening when the connector is inserted into the connector receptacle.

2. The connector of claim 1, wherein the electrical component is a chassis.

3. The connector of claim 1, wherein the inner wall has a depression and the clip is positioned in the depression such that the clip is retained by the inner wall.

4. The connector of claim 1, wherein the housing is a plastic housing.

5. The connector of claim 4, wherein the clip is made of a deformable material.

6. The connector of claim 5, wherein the deformable material is a metal.

7. The connector of claim 6, wherein the clip further comprises a second foot.

8. The connector of claim 7, wherein each foot comprises a tab.

9. The connector of claim 8, wherein the slot has a first and second protruding inner wall.

10. The connector of claim 9, wherein the inner wall has a first and second retaining depression.

11. The connector of claim 10, wherein the retaining depressions receive the tabs when the clip is slidably coupled to the housing.

12. (canceled)

13. (canceled)

14. The connector of claim 11, wherein a screw passes through the first and second openings thereby securing the clip to the electrical component.

15. A system, comprising:
a chassis coupled to a plurality of transceivers, the chassis having a receptacle electrically coupled to each of the transceivers, the chassis having a first opening;
a connector attached to the receptacle, the connector having a housing, a clip slidably coupled to the housing, and receptacles coupled to a plurality of subscriber lines, the receptacles housed within the housing, wherein each of a plurality of the receptacles is electrically coupled to a respective one of the transceivers and to a respective one of the subscriber lines, the clip having a second opening aligned with the first opening; and
a screw passing through the first and second openings thereby securing the clip to the chassis.

16. The system of claim 15, wherein the housing is a plastic housing.

17. The connector of claim 16, wherein the clip is composed of a deformable material.

18. The connector of claim 17, wherein the clip has a first foot and a second foot for slidably coupling the clip to the housing.

19. The connector of claim 18, wherein each foot has a tab.

20. The connector of claim 19, wherein the housing comprises a slot having a first and second protruding inner wall and at least one retaining depression.

21. The connector of claim 20, wherein the retaining depressions are positioned to receive the tabs when the clip is slidably coupled to the housing.

22. (canceled)

23. (canceled)

24. The system of claim 15, wherein the clip has a plurality of deformable feet, and wherein the feet deform as the clip is being slidably coupled to the housing.

25. The system of claim 24, wherein the clip has a surface through which the second opening passes, the surface substantially perpendicular to the feet.

26. The system of claim 15, wherein the chassis receptacle and the first opening pass through a surface of the chassis, and wherein the clip further comprises an attachment portion, the second opening passing through the attachment portion, the attachment portion substantially parallel to the surface of the chassis.

27. The system of claim 1, further comprising a screw passing through the first and second openings thereby securing the clip to the electrical component.

28. A method, comprising the steps of:
providing a housing having a receiving slot in a surface of the housing;
sliding a clip into the receiving slot;
coupling a plurality of receptacles within the housing to a receptacle of a chassis such that transceivers within the chassis are electrically coupled to the plurality of receptacles, wherein each of the plurality of receptacles is electrically coupled to a respective subscriber line; and
securing the clip to the chassis, wherein the securing step comprises the step of passing a screw through an opening in the clip and an opening in the chassis.
